(19) United States
(12) Patent Application Publication
(10) Pub. No.: US 2026/0296689 A1
(43) Pub. Date: Oct. 1, 2026

(54) MOTOR ASSEMBLY INCLUDING MOTOR CAPABLE OF BEING TILTED, AND UNMANNED AERIAL VEHICLE HAVING SAME

(71) Applicant: AIR & H AEROSPACE INC., Burnaby (CA)

(72) Inventor: Hong Yun LEE, Burnaby (CA)

(21) Appl. No.: 19/475,857

(22) PCT Filed: Apr. 19, 2024
(86) PCT No.: PCT/KR2024/005344

§ 371 Date: Oct. 16, 2025

(30) Foreign Application Priority Data
Apr. 20, 2023 (KR) 10-2023-0051724

(51) Int. Cl. B64U 30/297; B64U 10/20; B64U 50/13; B64U 50/19; H02P 5/48

(52) U.S. Cl. CPC B64U 30/297; B64U 10/20; B64U 50/13; B64U 50/19; H02P 5/48; B64U 2201/20

(57) ABSTRACT

An unmanned aerial vehicle according to a disclosed embodiment includes a body and two motor assemblies mounted on the body. At least one of the two motor assemblies includes a rotary actuator mounted on the body, a motor mount mounted on an output shaft of the rotary actuator, and a brushless direct current (BLDC) motor mounted on the motor mount and configured such that a rotary blade is mounted thereon. The rotary actuator is mounted on the body such that a rotation axis thereof forms a zero angle or an acute angle with a yaw axis of the body. The motor mount is configured to be tilted such that a rotation axis of the BLDC motor forms an acute angle with respect to the rotation axis of the rotary actuator.

### TECHNICAL FIELD

The present disclosure relates to a motor assembly provided with a tiltable motor, and an unmanned aerial vehicle including the same.

### BACKGROUND

An unmanned aerial vehicle, also known as a drone, is a remotely controlled aircraft. While initially developed for military purposes, the unmanned aerial vehicle is now used for a variety of commercial and civilian purposes. The most common form of the unmanned aerial vehicle is a multicopter including four or more rotors. However, the increased number of motors increases costs, and the weight of the motors themselves and the battery capacity required to operate them increases, leading to increased vehicle weight.

To address these shortcomings, there is available an unmanned aerial vehicle with a bicopter form factor, which includes two rotors. Controlling the attitude of a bicopter requires a separate mechanism capable of changing the direction of a propulsive force provided by the rotors. That is, a mechanism for tilting the axis of rotation of the rotor (or the motor mounted on the rotor) is required to control the vehicle. A representative example of this mechanism is a VTOL (Virtual Take-Off and Landing) type. In the VTOL type, thrust vectoring is achieved by rotating the motor around an axis perpendicular to the motor's axis of rotation. In the VTOL type, as the motor grows larger, its mass and volume also increase, thereby increasing the torque required to rotate the motor. Accordingly, a large-capacity actuator (e.g., a servo motor or a brushless direct current (BLDC) gimbal motor) is required to rotate the motor. Additionally, the attitude control of the aircraft is implemented by generating control signals at a relatively high update rate, typically about 400 Hz to 700 Hz. Since the motor must move rapidly in response to this update rate, a servo motor capable of providing a high rotational speed is required.

As mentioned above, the motor tilting method used in conventional bicopters requires a high-specification servo motor. As the motor size increases, the specifications required for an actuator that tilts the motor also increase. As actuator specifications increase, their weight and cost also increase, leading to problems such as increased weight and cost of an unmanned aerial vehicle provided with the same.

### DISCLOSURE

### Technical Problem

Various embodiments of the present disclosure provide a device capable of efficiently controlling the attitude of an unmanned aerial vehicle by tilting a rotation axis of a rotor with a simple and compact mechanism.

### Technical Solution

An unmanned aerial vehicle according to one embodiment includes: a body; and two motor assemblies mounted on the body, wherein at least one of the two motor assemblies includes a servo motor mounted on the body, a motor mount mounted on an output shaft of the servo motor, and a brushless direct current (BLDC) motor mounted on the motor mount and configured so that a rotary blade is mounted thereon, wherein the servo motor is mounted on the body such that a rotation axis thereof forms a zero angle or an acute angle with a yaw axis of the body, and wherein the motor mount is configured to be tilted such that a rotation axis of the BLDC motor forms an acute angle with the rotation axis of the servo motor.

In one embodiment, an angle at which the rotation axis of the servo motor is tilted with respect to the yaw axis may be the same as an angle at which the rotation axis of the BLDC motor is tilted with respect to the rotation axis of the servo motor.

In one embodiment, the rotation axis of the servo motor may be tilted at different angles with respect to the yaw axis in the two motor assemblies.

In one embodiment, the rotation axis of the BLDC motor and the rotation axis of the servo motor may intersect on a coupling plane of the motor mount and the BLDC motor.

A motor assembly for rotating a rotary blade of an unmanned aerial vehicle according to one embodiment includes: a servo motor; a motor mount mounted on an output shaft of the servo motor; and a BLDC motor mounted on the motor mount, wherein the motor mount is configured to be tilted such that a rotation axis of the BLDC motor forms an acute angle with a rotation axis of the servo motor.

In one embodiment, the rotation axis of the BLDC motor and the rotation axis of the servo motor may intersect on a coupling plane of the motor mount and the BLDC motor.

### Advantageous Effects

According to the present disclosure in some embodiments, a simple and compact motor assembly for tilting a rotation axis of a rotary blade, and an unmanned aerial vehicle having the motor assembly can be provided. Furthermore, by using the motor assembly of the present disclosure, the attitude of the unmanned aerial vehicle can be effectively controlled with a small number of motors.

### DESCRIPTION OF DRAWINGS

FIG. 1 is a perspective view of an unmanned aerial vehicle according to one embodiment.

FIG. 2 illustrates a change in motor attitude in response to a rotation of a motor mount as viewed from a side.

FIG. 3 illustrates a change in motor attitude in response to a rotation of the motor mount as viewed from the front.

FIG. 4 is a graph showing a change in thrust in response to a rotation of the motor mount.

FIG. 5 illustrates the unmanned aerial vehicle in a hovering state.

FIG. 6 illustrates the unmanned aerial vehicle in a forward movement state.

FIG. 7 illustrates the unmanned aerial vehicle in a turning state.

FIG. 8 illustrates a motor assembly in which a rotation axis of a servo motor is tilted relative to the yaw axis of a body.

FIG. 9 illustrates an assembly of a motor mount and a motor in one embodiment.

FIG. 10 illustrates a conventional VTOL method of tilting a motor.

### MODE FOR INVENTION

Embodiments of the present disclosure are illustrated for the purpose of explaining the technical idea of the present disclosure. The scope of the rights according to the present disclosure is not limited to the embodiments presented below or the detailed descriptions of such embodiments.

All technical and scientific terms used in the present disclosure have the meaning generally understood by those of ordinary skill in the art to which the present disclosure pertains, unless otherwise defined. All terms used in the present disclosure are chosen for the purpose of more clearly describing the present disclosure and are not chosen to limit the scope of rights according to the present disclosure.

As used in the present disclosure, expressions such as “comprising,” “including,” “having,” and the like are to be understood as open-ended terms having the possibility of encompassing other embodiments, unless otherwise mentioned in the phrase or sentence containing such expressions.

The singular form described in the present disclosure may include a plural meaning, unless otherwise mentioned. This applies equally to the singular form recited in the claims.

The expressions “first,” “second,” etc. used in the present disclosure are used to distinguish between multiple components, and do not limit the order or importance of the relevant components.

In the present disclosure, where it is mentioned in the present disclosure that one element is “connected” or “coupled” to another element, it is to be understood that said one element may be directly connected to said another element, or may be connected to said another element via a new additional element.

The dimensions and values described in the present disclosure are not limited to the described dimensions and values. Unless otherwise specified, these dimensions and values may be understood to mean the described values and equivalent ranges that include them. For example, the angle “10 degrees” described in the present disclosure may be understood to include “about 10 degrees.”

Hereinafter, descriptions are made for embodiments of the present disclosure with reference to the accompanying drawings. In the accompanying drawings, the same or corresponding elements are denoted by the same reference numerals. In the following descriptions of the embodiments, descriptions of the same or corresponding elements may be omitted. However, even if the descriptions of elements are omitted, it is not intended that such elements are not included in a certain embodiment.

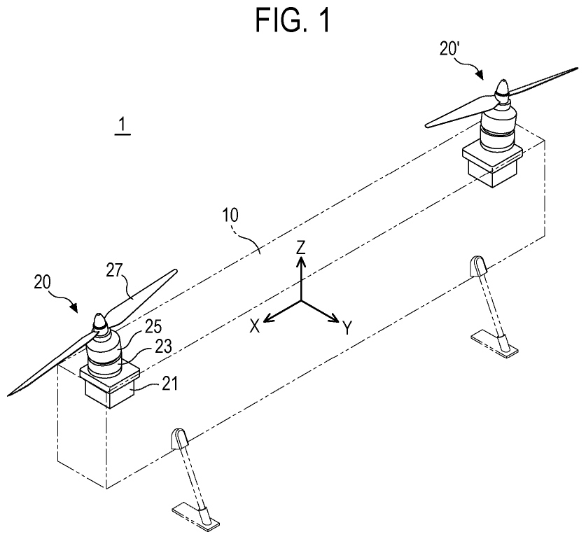

FIG. 1 is a perspective view of an unmanned aerial vehicle 1 according to one embodiment.

Referring to FIG. 1, the unmanned aerial vehicle 1 includes a body 10 and at least one motor assembly 20 coupled to the body 10. For example, the unmanned aerial vehicle 1 may include a first motor assembly 20 and a second motor assembly 20′ respectively disposed at the front and rear ends of the body 10 in a longitudinal X-axis direction.

The motor assembly 20 includes a rotary actuator 21, a motor mount 23 mounted on an output shaft of the rotary actuator 21, and a motor 25 mounted on the motor mount 23. The rotary actuator 21 includes an output shaft and is configured to control a rotation angle and an angular velocity of the output shaft. The rotary actuator 21 may be, for example, a servo motor or a BLDC gimbal motor. The rotary actuator 21 is fixedly mounted to the body 10. The motor mount 23 rotates about a rotation axis A2 of the rotary actuator 21 in response to an operation of the rotary actuator 21. The motor 25 is fixedly mounted on the motor mount 23, and the motor 25 rotates about the rotation axis A2 of the rotary actuator 21 together with the motor mount 23.

The motor 25 is, for example, a brushless direct current (BLDC) motor. The motor 25 is configured to be mounted with a rotary blade 27. For example, the rotary blade 27 is mounted on an output shaft of the motor 25. The rotary blade 27 may be, for example, a rotor or a propeller. The motor assembly 20 or the unmanned aerial vehicle 1 of the present disclosure may be provided to a user without the rotary blade 27. In this case, the user may use the unmanned aerial vehicle 1 after attaching the rotary blade 27 to the motor 25.

The motor mount 23 is configured to be tilted so that the rotation axis A1 of the motor 25 forms an acute first angle θ1 with the rotation axis A2 of the rotary actuator 21. While the motor mount 23 is rotated by the rotary actuator 21, the trajectory of the rotation axis A1 of the motor 25 may have a shape like a side surface of a cone having the rotation axis A2 of the rotary actuator 21 as its central axis.

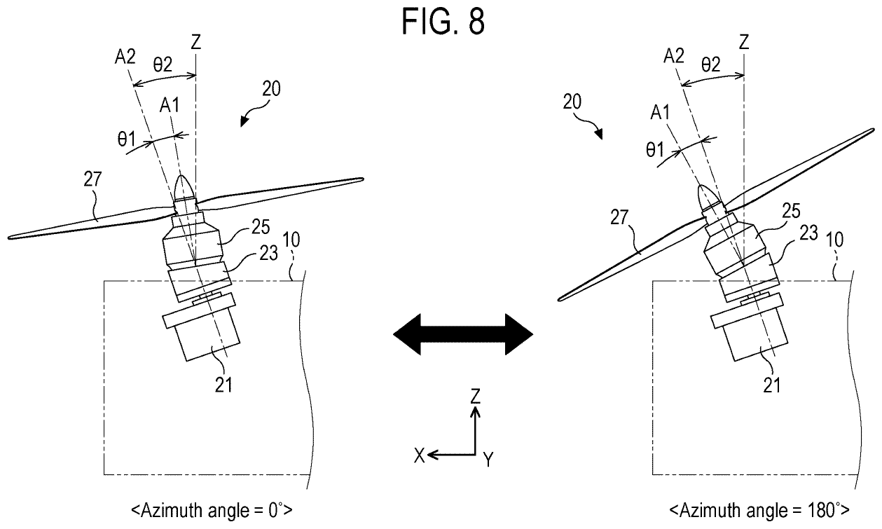

The rotation axis A2 of the rotary actuator 21 may form 0 degrees or an acute second angle θ2 with the yaw axis Z (see FIG. 8). For example, the rotary actuator 21 may be mounted on the body 10 such that the rotation axis A2 forms 0 degrees or an acute angle with the yaw axis of the body 10. The yaw axis Z is an axis that is parallel to the up-down direction of the body 10, and the body 10 yaws about the yaw axis.

The direction of the rotation axis A1 of the motor 25 is the same as the direction of the thrust caused by the rotation of the rotary blade 27 mounted on the motor 25. Since the direction of the rotation axis A1 of the motor 25 in the unmanned aerial vehicle 1 of the present disclosure is changed by the rotation of the motor mount 23, the direction of the thrust of the motor 25 may be changed, and accordingly, the attitude of the unmanned aerial vehicle 1 in the air may be controlled.

In the present disclosure, the unmanned aerial vehicle 1 is provided in the form of a bicopter having two rotary blades 27. However, the embodiment of the present disclosure is not limited thereto. In another embodiment, the motor assembly 20 of the present disclosure may be applied to a multi-copter having three or more rotary blades. For example, at least one of three motors provided in a tri-copter having three rotary blades may be configured like the motor assembly 20 of the present disclosure.

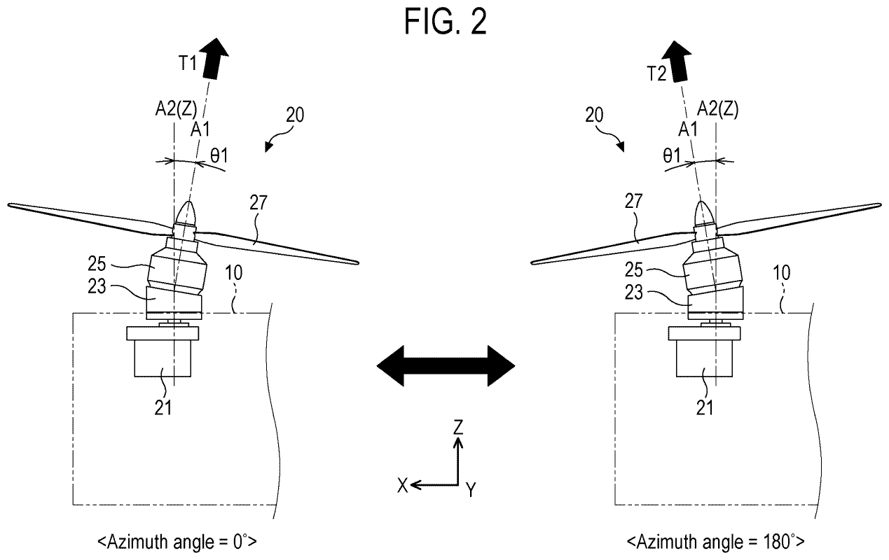

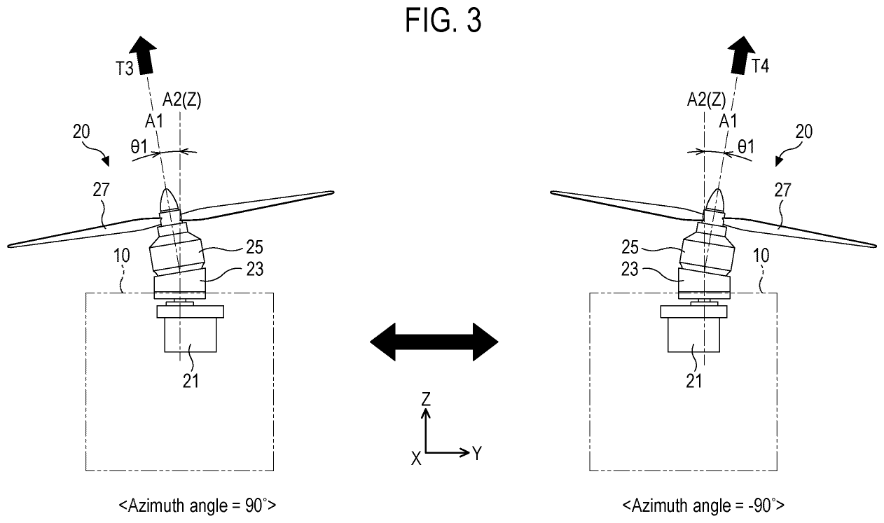

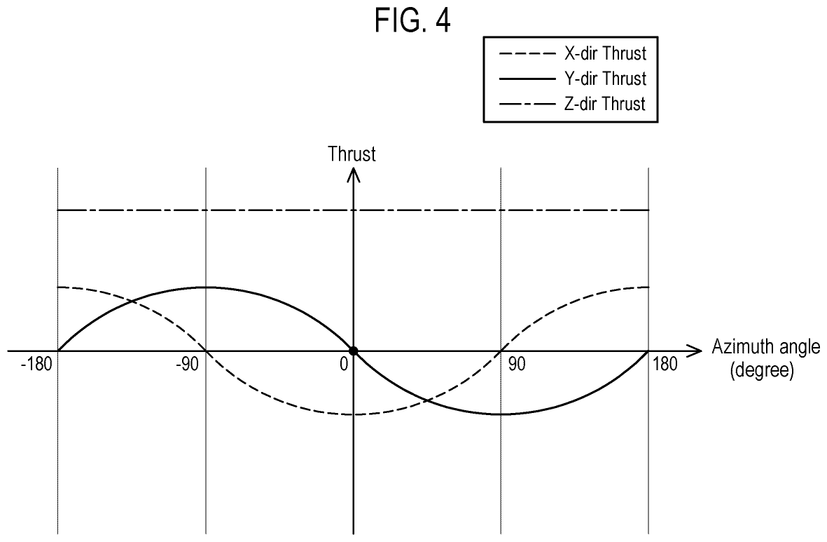

FIG. 2 illustrates a change in attitude of the motor 25 according to the rotation of the motor mount 23 when viewed from a side. FIG. 3 illustrates a change in attitude of the motor 25 according to a rotation of the motor mount 23 when viewed from the front. FIG. 4 is a graph showing a change in thrust according to the rotation of the motor mount 23.

FIGS. 2 and 3 illustrate one motor assembly 20 provided in the unmanned aerial vehicle 1. Another motor assembly 20′ provided in the unmanned aerial vehicle 1 may be the same as or different from the illustrated motor assembly 20.

Referring to FIG. 2, when in a state on the left side, the rotation axis A1 of the motor 25 is tilted to the right by a predetermined angle θ1 with respect to the rotation axis A2 of the rotary actuator 21. The azimuth angle of the motor 25 in this state is defined as 0 degrees. Since the direction of the thrust T1 of the motor 25 is upward of the motor 25 along the rotation axis A1 of the motor 25, in this case, the thrust T1 includes a rightward vector component, i.e., a −X direction vector component.

When the motor mount 23 is rotated 180 degrees by the rotary actuator 21, the attitude of the motor 25 is changed to a state on the right side (azimuth angle=180 degrees). In this case, the rotation axis A1 of the motor 25 is tilted to the left by a predetermined angle θ1 with respect to the rotation axis A2 of the rotary actuator 21, and the thrust T2 by the motor 25 includes a leftward vector component, i.e., a+X direction vector component.

Referring to FIG. 3, when in a state on the left side (azimuth angle=90 degrees), the rotation axis A1 of the motor 25 is tilted to the left by a predetermined angle θ1 with respect to the rotation axis A2 of the rotary actuator 21. In this case, the thrust T3 includes a leftward vector component, i.e., a −Y direction vector component. When the motor mount 23 is rotated 180 degrees by the rotary actuator 21, the attitude of the motor 25 is changed to a state on the right side (azimuth angle=−90 degrees). In this case, the rotation axis A1 of the motor 25 is tilted to the right by a predetermined angle θ1 with respect to the rotation axis A2 of the rotary actuator 21, and the thrust T4 by the motor 25 includes a rightward vector component, i.e., a +Y direction vector component.

FIG. 4 shows a change in thrust in the X-, Y-, and Z-axis directions according to the change in the attitude of the motor 25. Referring to the graph, when the azimuth angle of the motor 25 is 0 degrees, the magnitude of the X-direction thrust (X-dir Thrust) is maximum, and the magnitude of the Y-direction thrust (Y-dir Thrust) is 0. When the motor 25 is rotated by the rotary actuator 21 and the azimuth angle of the motor 25 is changed from 0 degrees to 90 degrees, the magnitude of the Y-direction thrust becomes maximum, and the magnitude of the X-direction thrust becomes 0. When the motor 25 is rotated by the rotary actuator 21 and the azimuth angle of the motor 25 is changed from 0 degrees to −90 degrees, the magnitude of the Y-direction thrust increases, and the magnitude of the X-direction thrust becomes 0. When the azimuth angle is −90 degrees, the Y-direction thrust is equal in magnitude to, and opposite in direction to, the Y-direction thrust when the azimuth angle is 90 degrees. As the azimuth angle of the motor 25 is changed from 90 degrees or −90 degrees to 180 degrees or −180 degrees, the magnitude of the Y-direction thrust becomes 0, and the magnitude of the X-direction thrust gradually increases. The X-direction thrust in the range of azimuth angle −180 degrees to −90 degrees or 90 degrees to 180 degrees is opposite in direction to the X-direction thrust in the range of azimuth angle −90 degrees to 90 degrees.

Since the rotation axis A2 of the rotary actuator 21 is parallel to the Z-axis direction, the Z-direction thrust (Z-dir Thrust) does not change and remains constant as the azimuth angle changes. FIG. 4 assumes that the rotation axis A2 of the rotary actuator of the motor assembly 20 in the unmanned aerial vehicle 1 is parallel to the Z axis. In a case where the rotation axis A2 of the rotary actuator is not parallel to the Z axis as shown in FIG. 8 described below, the X-direction thrust, the Y-direction thrust, and the Z-direction thrust will change in a different manner from those shown in FIG. 4. For example, the Z-direction thrust may change according to the azimuth angle.

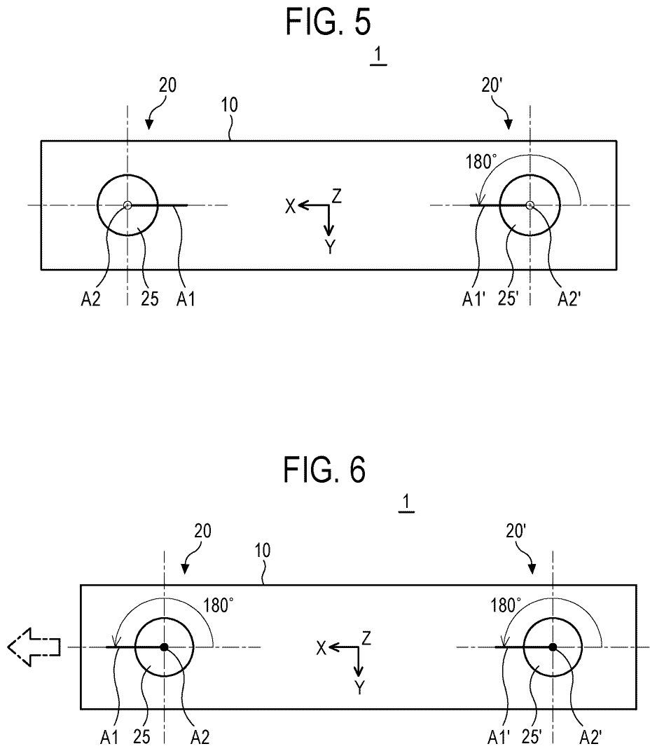

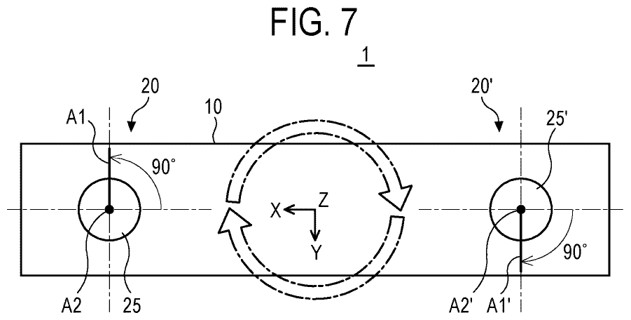

FIGS. 5 to 7 illustrate a motion of the unmanned aerial vehicle 1 according to the azimuth angles of the motors 25 and 25′ of the two motor assemblies 20 and 20′ in an exemplary embodiment. FIG. 5 illustrates the unmanned aerial vehicle 1 in a hovering state. FIG. 6 illustrates the unmanned aerial vehicle 1 in a forward movement state. FIG. 7 illustrates the unmanned aerial vehicle 1 in a turning state. In the unmanned aerial vehicle 1 of FIGS. 5 to 7, it is assumed that the rotation axes A2 and A2′ of the rotary actuators of the two motor assemblies 20 and 20′ are parallel to the Z axis, and the angles formed by the rotation axes A1 and A1′ of the motors 25 and 25′ of the two motor assemblies 20 and 20′ with respect to the axes A2 and A2′ of the rotary actuators are the same.

Referring to FIG. 5, the azimuth angle of the first motor 25 is 0 degrees, and the azimuth angle of the second motor 25′ is 180 degrees or −180 degrees. In this state, if the outputs of the two motors 25 and 25′ are the same, the X-axis component of the thrust of the first motor 25 and the X-axis component of the thrust of the second motor 25′ cancel each other out, so that the X-axis component of the total thrust becomes 0. In this case, the unmanned aerial vehicle 1 may be in a hovering state in which it does not move on the X-Y plane. Although not shown, even when the azimuth angles of the first motor 25 and the second motor 25′ are 180 degrees and 0 degrees, respectively, the unmanned aerial vehicle 1 may be in the hovering state in which it does not move on the X-Y plane.

Referring to FIG. 6, the azimuth angles of the first motor 25 and the second motor 25′ are 180 degrees or −180 degrees. In this state, the total thrust has an X-axis component pointing in the +X direction, and the unmanned aerial vehicle 1 can move in the +X direction. Conversely, although not shown, when the azimuth angles of the first motor 25 and the second motor 25′ are 0 degrees, the unmanned aerial vehicle 1 can move in the −X direction. When the thrust in the +X direction or −X direction is generated by the two motors 25 and 25′, the unmanned aerial vehicle 1 can rotate about the pitch axis, i.e., the Y axis.

Referring to FIG. 7, the azimuth angle of the first motor 25 is 90 degrees, and the azimuth angle of the second motor 25′ is −90 degrees. In this state, the thrust of the first motor 25 has a component in the −Y direction, and the thrust of the second motor 25′ has a component in the +Y direction. In this case, the unmanned aerial vehicle 1 can rotate clockwise about the Z axis. Conversely, although not shown, when the azimuth angle of the first motor 25 is −90 degrees and the azimuth angle of the second motor 25′ is 90 degrees, the unmanned aerial vehicle 1 can rotate counterclockwise about the Z axis.

Although not shown, when the azimuth angles of the first motor 25 and the second motor 25′ are both 90 degrees, the thrust of the first motor 25 and the second motor 25′ has a component in the −Y direction (see FIG. 4), in which case the unmanned aerial vehicle 1 can move in the −Y direction. Conversely, when the azimuth angles of the first motor 25 and the second motor 25′ are both −90 degrees, the thrust of the first motor 25 and the second motor 25′ has a component in the +Y direction (see FIG. 4), in which case the unmanned aerial vehicle 1 can move in the +Y direction. When the thrust in the +Y direction or the −Y direction is generated by the two motors 25 and 25′, the unmanned aerial vehicle 1 can rotate around the roll axis, i.e., the X axis.

By making the rotation speeds of the first motor 25 and the second motor 25′ different from each other, the pitch of the unmanned aerial vehicle 1 can be adjusted. In this case, the moment generated by the two motors 25 and 25′ can cause the unmanned aerial vehicle 1 to rotate about the yaw axis Z. In order to suppress unintended yaw movement generated due to the difference in rotation speeds of the motors 25 and 25′, the azimuth angles of the motors 25 and 25′ may be adjusted.

FIG. 8 illustrates a motor assembly 20 in another embodiment.

Referring to FIG. 8, the rotary actuator 21 may be installed on the body 10 such that the rotation axis A2 of the rotary actuator 21 is tilted at a second angle θ2, which is an acute angle with respect to the Z axis. For example, the second angle θ2 may be 10 degrees.

When the azimuth angle of the motor 25 is 0 degrees, the rotation axis A1 of the motor 25 forms an angle of “second angle θ2−first angleθ1” with the Z axis. When the azimuth angle of the motor 25 is 180 degrees, the rotation axis A1 of the motor 25 forms an angle of “second angle θ2+first angleθ1” with the Z axis. FIG. 8 shows an embodiment when the second angle θ2 is larger than the first angle θ1. In this case, regardless of the azimuth angle of the motor 25, the thrust of the motor 25 includes a vector component pointing in the left +X direction.

In another embodiment, the angle at which the rotation axis A2 of the rotary actuator 21 is tilted with respect to the yaw axis Z may be set to be the same as the angle at which the rotation axis A1 of the motor 25 is tilted with respect to the rotation axis A2 of the rotary actuator 21. That is, the first angle θ1 and the second angle θ2 may be equal to each other. For example, when the rotary actuator 21 is mounted on the body 10 such that its rotation axis is tilted at 10 degrees with respect to the yaw axis Z, the motor mount 23 may be configured such that the rotation axis A1 of the motor 25 forms an angle of 10 degrees with respect to the rotation axis A2 of the rotary actuator 21. In this case, when the azimuth angle of the motor 25 is 0 degrees, the rotation axis A1 of the motor 25 is parallel to the Z axis, and the thrust of the motor 25 is composed only of a vector in the Z-axis direction.

In another embodiment, the second angle θ2 may be less than the first angle θ1. For example, the second angle θ2 may be 5 degrees and the first angle θ1 may be 10 degrees. In this case, as the azimuth angle of the motor 25 rotates from 0 degrees to 180 degrees or −180 degrees, the vector component of the thrust of the motor 25 in the X-axis direction may point to the left or right.

When the unmanned aerial vehicle 1 includes a plurality of motor assemblies (e.g., the first motor assembly 20 and the second motor assembly 20′ shown in FIG. 1), the rotation axes of the plurality of motors respectively provided in the plurality of motor assemblies may be tilted at different angles with respect to the rotation axes of the plurality of rotary actuators. For example, the first angle θ1 in the first motor assembly 20 may be 10 degrees, and the first angle θ1 in the second motor assembly 20′ may be 5 degrees.

When the unmanned aerial vehicle 1 includes a plurality of motor assemblies (e.g., the first motor assembly 20 and the second motor assembly 20′ shown in FIG. 1), some or all of the plurality of rotary actuators respectively provided in the plurality of motor assemblies may be installed in the body 10 such that their rotation axes A2 are tilted with respect to the Z axis as shown in FIG. 8. The rotation axes A2 of the plurality of rotary actuators 21 in the plurality of motor assemblies may be tilted at different angles with respect to the yaw axis Z. For example, in the first motor assembly 20, the second angle θ2 may be 10 degrees, and in the second motor assembly 20′, the second angle θ2 may be 0 degrees.

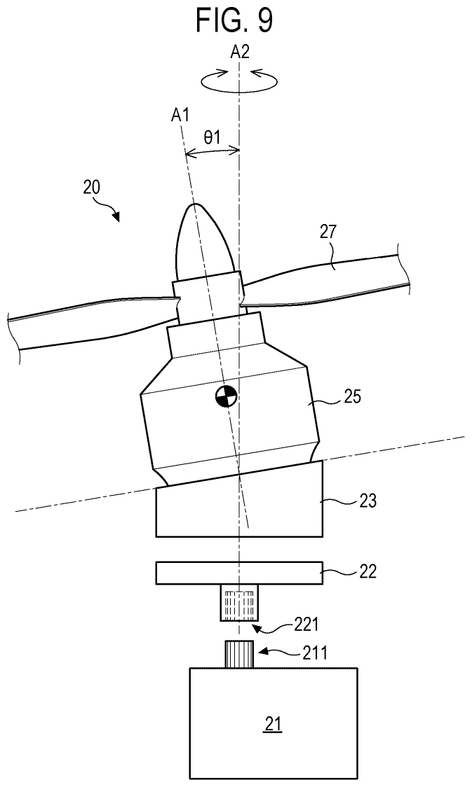

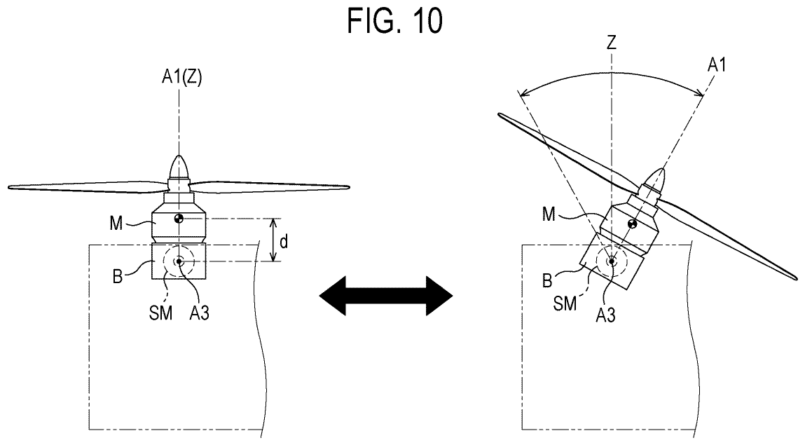

FIG. 9 illustrates an assembly of the motor mount 23 and the motor 25. FIG. 10 illustrates a conventional VTOL method of tilting a motor M.

Referring to FIG. 9, the rotation axis A2 of the rotary actuator 21 may intersect the rotation axis A1 of the motor 25 on a coupling surface of the motor mount 23 and the motor 25. That is, the point where the rotation axis A2 of the rotary actuator 21 and the rotation axis A1 of the motor 25 intersect may be located on the coupling surface of the motor mount 23 and the motor 25. As a result of the coupling as above, the center of gravity of the motor 25 is located close to the rotation axis A2 of the rotary actuator 21. In this case, the rotational moment of inertia of the motor 25 about the rotation axis A2 of the rotary actuator 21 is reduced, and therefore, the motor 25 can be rotated even by the rotary actuator 21 having a relatively small output. If the output required for the rotary actuator 21 is reduced, its size or weight can be reduced, which can contribute to reducing the overall size and weight of the unmanned aerial vehicle 1. However, in the embodiment of the present disclosure, the relative positions of the motor 25 and the motor mount 23 are not limited to those shown in FIG. 9. For example, the motor 25 may be mounted on the motor mount 23 so that the center of gravity of the motor 25 is located on the rotation axis A2 of the rotary actuator 21. In this case, the rotational moment of inertia of the motor 25 is further reduced, which makes it possible to further maximize the above-mentioned effect.

The motor mount 23 may be coupled to the rotary actuator 21 via a hub shaft 22. For example, the hub shaft 22 may be coupled to the output shaft 211 of the rotary actuator 21, and the motor mount 23 may be coupled to the hub shaft 22. For example, the hub shaft 22 may include a hole 221 that engages with a spline provided on the outer periphery of the output shaft 211 of the rotary actuator 21. In another embodiment, the motor mount 23 and the hub shaft 22 may be formed integrally.

Referring to FIG. 10, a rotation axis A3 of a rotary actuator SM is orthogonal to the rotation axis A1 of the motor M. The motor M is mounted on a bracket B mounted on an output shaft of the rotary actuator SM. As the bracket B is turned due to the operation of the rotary actuator SM, the motor M can be turned to adjust the direction of the thrust of the motor M.

Assuming that the motor 25 is a cylinder with a mass m, a radius r, and a height h, the moment of inertia of the motor 25 with respect to the rotation axis A2 of the rotary actuator 21 is approximately ½·m·r²+ 1/12·m·(3·r²+h²)sin(θ1) in FIG. 9. As the motor 25 grows larger in size, the radius r and the height h increase. However, since the first angle θ1 is an acute angle, the extent to which these increases contribute to the moment of inertia decreases. In particular, when the first angle θ1 is a small angle, such as 10 degrees, the increase in the moment of inertia due to the increase in the size of the motor 25 becomes even smaller. Therefore, in the motor assembly 20 of the present disclosure, the requirements for the rotary actuator 21 do not change significantly according to the change in the size of the motor 25.

In FIG. 10, if the motor M is the same motor 25 as in FIG. 9, and the distance between the rotation axis A3 of the rotary actuator SM and the center of the motor M is d, the moment of inertia of the motor M with respect to the rotation axis A3 of the rotary actuator SM is approximately 1/12·m·(3·r²+h²)+m·d². As the motor M grows larger in size, the radius r and the height h increase, and the distance d may also increase. Since the moment of inertia increases squarely as the radius r, the height h, and the distance d increase, the torque proportional to the moment of inertia also increases squarely. Ultimately, in the VTOL type motor tilting method, as the motor M grows larger in size, a rotary actuator SM with high specifications is required.

In addition, the moment of inertia of the motor 25 with respect to the rotation axis A2 of the rotary actuator 21 of the present disclosure is smaller than the moment of inertia of the motor M with respect to the rotation axis A3 of the rotary actuator SM in the conventional motor tilting method. This is partly because, compared to the “md²” term of the moment of inertia in the VTOL type motor tilting method, the size thereof is greatly increased, whereas the motor assembly 20 of the present disclosure does not have such a term. The smaller the moment of inertia of an object, the easier it is to rotate the object. Therefore, according to the embodiment of the present disclosure, the attitude of the motor 25 can be efficiently and quickly changed, and hence, the attitude of the unmanned aerial vehicle 1 can be effectively controlled.

The technical idea of the present disclosure has been described heretofore with reference to some embodiments and examples shown in the accompanying drawings. However, it is to be understood that various substitutions, modifications and alterations may be made without departing from the technical idea and scope of the present disclosure that can be understood by those of ordinary skill in the technical field to which the present disclosure pertains. Further, it is to be understood that such substitutions, modifications and alterations fall within the scope of the appended claims.

1-6. (canceled)

7. An unmanned aerial vehicle, comprising:
a body; and
two motor assemblies mounted on the body,
wherein at least one of the two motor assemblies includes a rotary actuator mounted on the body, a motor mount mounted on an output shaft of the rotary actuator, and a brushless direct current (BLDC) motor mounted on the motor mount and configured such that a rotary blade is mounted thereon,
wherein the rotary actuator is mounted on the body such that a rotation axis (A2) thereof forms a zero angle or an acute angle with a yaw axis of the body, and
wherein the motor mount is configured to be tilted such that a rotation axis (A1) of the BLDC motor forms an acute angle with respect to the rotation axis (A2) of the rotary actuator.

8. The unmanned aerial vehicle of claim 7, wherein an angle at which the rotation axis (A2) of the rotary actuator is tilted with respect to the yaw axis is set to be equal to an angle at which the rotation axis (A1) of the BLDC motor is tilted with respect to the rotation axis (A2) of the rotary actuator.

9. The unmanned aerial vehicle of claim 7, wherein the rotation axis (A2) of the rotary actuator is tilted at different angles with respect to the yaw axis in each of the two motor assemblies.

10. The unmanned aerial vehicle of claim 7, wherein the rotation axis (A1) of the BLDC motor and the rotation axis (A2) of the rotary actuator intersect on a coupling plane of the motor mount and the BLDC motor.

11. A motor assembly for rotating a rotary blade of an unmanned aerial vehicle, comprising
a rotary actuator;
a motor mount mounted on an output shaft of the rotary actuator; and
a BLDC motor mounted on the motor mount,
wherein the motor mount is configured such that a rotation axis (A1) of the BLDC motor is configured to be tilted so as to form an acute angle with respect to a rotation axis (A2) of the rotary actuator.

12. The motor assembly of claim 11, wherein the rotation axis (A1) of the BLDC motor and the rotation axis (A2) of the rotary actuator intersect on a coupling plane of the motor mount and the BLDC motor.
